(19) United States
(12) Patent Application Publication
(10) Pub. No.: US 2010/0254684 A1
(43) Pub. Date: Oct. 7, 2010

(54) DISTRIBUTION SYSTEM OF CONTENTS

(75) Inventors: Mamoru Saitoh, Kanagawa (JP); Masahito Kasai, Kanagawa (JP)

Correspondence Address: Muncy, Geissler, Olds & Lowe, PLLC, 4000 Legato Road, Suite 310, FAIRFAX, VA, 22033, US

(73) Assignee: PLANNET ASSOCIATE CO., LTD., Yokohama City, Kanagawa (JP)

(21) Appl. No.: 12/740,155

(22) PCT Filed: Sep. 29, 2009
(86) PCT No.: PCT/JP2009/066989

§ 371 Date: Apr. 28, 2010

(30) Foreign Application Priority Data
Oct. 6, 2008 (JP) 2008-259993
Dec. 24, 2008 (JP) 2008-327415
Apr. 16, 2009 (JP) 2009-100215
May 14, 2009 (JP) 2009-117117

(51) Int. Cl. H04N 5/00; G06F 17/30

(52) U.S. Cl. 386/126; 707/827; 707/E17.01; 386/E05.064

(57) ABSTRACT

Disclosed is a distribution system of contents, comprising a distribution server 4 stored with a content having a management file and a plurality of stream files with different data amounts and a player apparatus 1 for downloading the content via a communication line 5 and starting playback of the content during the downloading. The player apparatus comprises a detector unit 16 for detecting a transmission speed through the communication line, a selector unit 17 for selecting a stream file with a data amount depending on the transmission speed from the plurality of stream files with different data amounts, a stream file memory unit 14 for downloading and temporally memorizing the selected stream file, and a volume adjuster unit 15 for adding a padding data such that the data amount of the stream file becomes equal to a data amount specified in the management file when the data amount of the stream file is different from the data amount specified in the management file.

### TECHNICAL FIELD

The present invention relates to a distribution system and a program thereof for performing a progressive download playback (pseudo streaming playback) to play various contents, such as movies and motion pictures taken by a video camera, while downloading the contents.

The present invention also relates to a conversion processing method, a conversion processing apparatus, and a conversion processing program for conversion processing a picture signal by VC-1 encoding method with respect to the contents.

### BACKGROUND ART

Patent document 1 discloses a distribution system and a playing method of contents for performing a progressive download playback. The distribution system disclosed in Patent document 1 is a system in which playback bit rate information is added to a content when a distribution server transmits the content to a receiving client via the internet, the receiving client determines, based on the playback bit rate information, whether or not the progressive download playback is capable of being performed, and the playback is started when being possible.

On the other hand, stream files according to VC-1 (Video Codec-1) encoding method, which are playable by using a software for Windows Media Player (registered trademark; hereinafter also abbreviated as “WMP”), are assigned with three kinds of profiles, i.e. a simple profile, a main profile, and an advanced profile (refer to paragraph 0023 of Patent document 2). Among these, there is no data compatibility between the simple or main profile and the advanced profile. In addition, the advanced profile according to VC-1 is playable on Blu-ray players, whereas neither the simple profile nor the main profile is playable on Blu-ray players.

### PRIOR ART DOCUMENTS

[Patent Documents]

[Patent Document 1] Japanese Patent Application Publication No. 2008-278090

[Patent Document 2] International Patent Publication No. WO2006/025527

### SUMMARY OF THE INVENTION

### Problems to be Solved by the Invention

According to the prior art described in Patent document 1, at the time of the above progressive download playback, the download must be continued until the playback is to be enable, in the case that the progressive download playback is determined as not being ready to start. Thus, there occurs a waiting time or an interruption time for users before starting the playback.

In considering the above, it may be proposed to prepare a plurality of stream files with different data amounts in the distribution server and select a stream file with an appropriate data amount depending on the transmission speed of the network. However, because the data amount of the stream file is preliminarily defined by a clip info file corresponding to the stream file, it is unable to play the stream file with a data amount different from the defined data amount in spite of having been downloaded.

The first object of the present invention is, therefore, to provide a distribution system and a program capable of performing a progressive download playback without a waiting time or an interruption time.

Incidentally, in order for a Blu-ray player apparatus to play the simple or main profile of VC-1 with respect to the stream file according to the above VC-1 encoding method, it is required to perform an off-line decoding of the simple or main profile and to encode again the decoded profile by an encoder for the advanced profile. Therefore, it is unable to play in real time the simple or main profile on a Blu-ray player apparatus.

The second object of the present invention is to provide a method, an apparatus, and a program capable of playing, on a Blu-ray player apparatus, picture signals according to the VC-1 encoding method in real time.

### Means for Solving the Problems

According to an aspect of the present invention, the above first object is achieved through selecting a stream file with a data amount depending on a transmission speed, from a plurality of stream files with different data amounts, and adjusting the data amount of the selected stream file to a data amount specified by a management file.

According to an another aspect of the present invention, the above second object is achieved through addition processing an offset value to a frequency component of signal obtained by decoding a pixel signal of the simple profile or the main profile according to VC-1. The offset value is determined as a frequency component depending on a constant to be added to a pixel signal in a decoding process of the advanced profile.

### Advantageous Effect of the Invention

According to the present invention, it is enabled to perform a progressive download playback without a waiting time or an interruption time.

Also according to the present invention, the addition processing of an offset value, which is provided as a frequency component depending on a constant to be added to a pixel signal in a decoding process of the advanced profile, is performed for the frequency component of a pixel signal generated by decoding. Therefore, the offset value is enable to compensate for the constant even if it is added to a pixel signal obtained through an inverse signal conversion processing. Because such addition processing of the offset value is executable by a simple program, it is enable to play in real time the simple or main profile of VC-1 through using an algorithm same as for the advanced profile, i.e. through using a Blu-ray player apparatus.

### BRIEF DESCRIPTION OF DRAWINGS

FIG. 1 is a block diagram illustrating a distribution system of digital data, which uses a program according to the first embodiment of the present embodiment.

FIG. 2 is a data structure diagram illustrating a play list file, clip info files, and stream files used in the distribution system of digital data shown in FIG. 1.

FIG. 3 is a data structure diagram illustrating three stream files with different data amounts stored in a distribution server shown in FIG. 1.

FIG. 4 is a data structure diagram for explaining an adjustment of data amount executed in a player apparatus shown in FIG. 1.

FIG. 5 is a data structure diagram for explaining an adjustment of data amount of I picture executed in the player apparatus shown in FIG. 1.

FIG. 6 is a block diagram illustrating a digital audio and visual information recording apparatus applied with the second and the third embodiments according to the present invention.

FIG. 7 is a view illustrating a top menu at the time of playing a BD (Blu-ray disc) prepared by using the recording apparatus shown in FIG. 6.

FIG. 8 is a view illustrating a playback picture and the top menu at the time of playing the BD prepared by using the recording apparatus shown in FIG. 6.

FIG. 9 is a block diagram illustrating a structure which includes a top menu of BD-Live at the time of playing the BD prepared by using the recording apparatus shown in FIG. 6.

FIG. 10A is a view illustrating contents of downloaded product information selected from the top menu shown in FIG. 9.

FIG. 10B is a view illustrating contents of peripheral accessory net shop selected from the top menu shown in FIG. 9.

FIG. 10C is a view illustrating contents of audio and visual uploading selected from the top menu shown in FIG. 9.

FIG. 10D is a view illustrating contents of other company's advertising selected from the top menu shown in FIG. 9.

FIG. 10E is a view illustrating contents of other company's net shop selected from the top menu shown in FIG. 9.

FIG. 11 is a flow chart illustrating a conversion processing method of picture signal applied with the fourth embodiment according to the present invention.

FIG. 12 is a block diagram illustrating an example of a conversion processing apparatus which executes the conversion process of picture signal shown in FIG. 11.

### EMBODIMENTS FOR CARRYING OUT THE INVENTION

### First Embodiment

The present embodiment involves a player apparatus 1 which complies with the BD-LIVE specification. The player apparatus 1 is connected with a distribution server 4 via an internet 5, and performs a so-called progressive download playback to start playing desired contents, such as movies, and motion pictures taken by a video camera, while downloading the contents. The progressive download playback is performed in accordance with a program, such as Java (registered trade mark) program, capable of being recorded and executed responding to the format of Blu-ray disc medium (also abbreviated as BD).

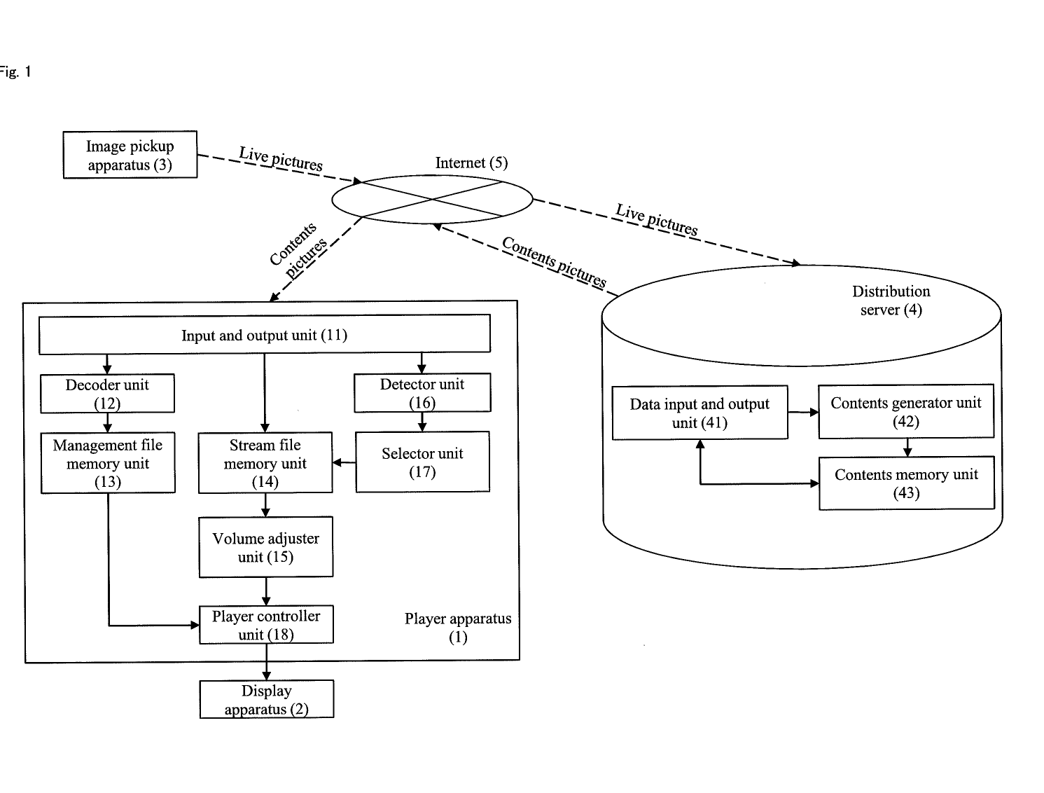

The player apparatus 1 shown in FIG. 1 is an apparatus which has an input section for a BD, a CPU for information processing, and an output section to a display apparatus 2 thereby being playable of information according to the BD format. The player apparatus 1 is illustrated in FIG. 1 as functional blocks indicating a situation that the substance of a program is installed for the CPU for information processing after a BD in which a Java (registered trade mark) program is recorded is set in the input section of the player apparatus 1. It is to be noted that the program according to the present invention may be downloaded from the distribution server 4 in addition to being recorded in a BD.

After the program according to the present embodiment is read into the player apparatus 1, there are developed various functions such as an input and output unit 11, a decoder unit 12, a management file memory unit 13, a stream file memory unit 14, a volume adjuster unit 15, a detector unit 16, a selector unit 17, and a player controller unit 18.

The input and output unit 11 outputs a download request for a certain content to the distribution server 4 and inputs the downloaded content. In response to the download request, options of “down load” and “progressive down load playback” are prepared on a download screen regarding the distribution server. Clicking “download” allows to perform a conventional download and the downloaded content is recorded into a memory not shown, whereas clicking “progressive download playback” allows to perform the progressive download playback. Hereinafter, the description will be directed to the progressive download playback, and the description of the conventional download will be omitted.

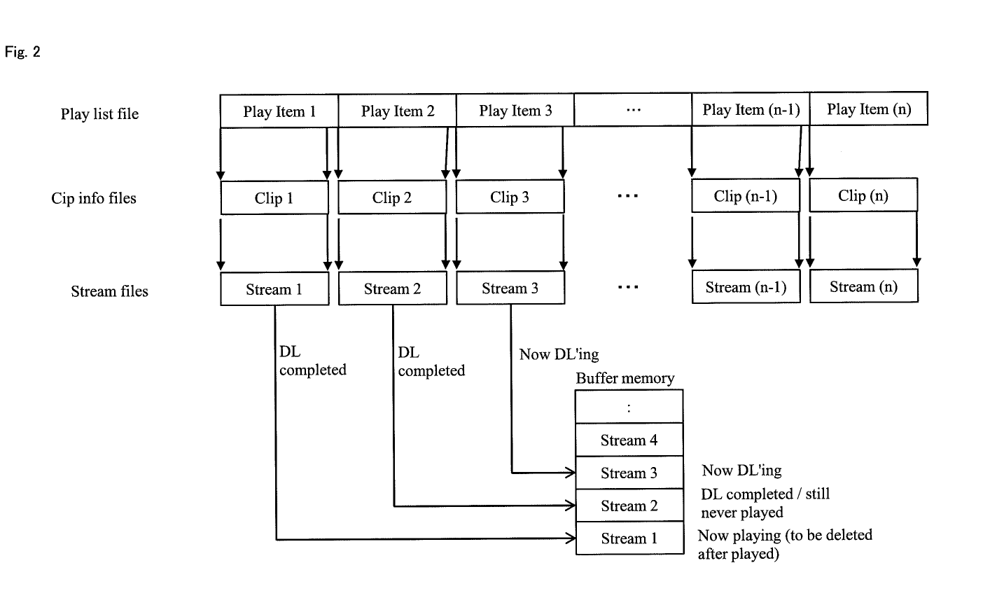

Referring to FIG. 2, the data structure of a content to be handled in the present embodiment is illustrated. In this case, one content (one movie, for example) contains a play list file, clip info files, and stream files. The play list file is a file to hold information for performing a stream playback, and has a plurality of play items 1, 2, . . . , n. One content is assigned with one file of the play list file.

The clip info files reside as a plurality of clip info files 1, 2, . . . , n respectively corresponding to the play items of the play list file. Each clip info file holds information relevant to size, play time, and the like of the corresponding stream file.

The stream files, each of which resides as one file for each pair of the corresponding play item and the corresponding clip info file, are AV stream files for playback, such as motion picture files of m2ts stored under the motion picture compression standard of H.264/MPEG-4 AVC format, for example. Accordingly, the number of the stream files is same as the number of the clip info files. Thus, one clip info file and one stream file exist so as to correspond to the relevant play list, thereby enabling to playback.

Referring again to FIG. 1, the decoder unit 12 is provided to decode or decrypt clip info files encrypted in the distribution server 4. In the case that the volume of content is large, considerable clip info files reside for one play list file. In order for the download time of the clip info files to be shortened, the clip info files are encrypted (compressed) in accordance with a certain algorithm at the distribution server 4 side. The decoder unit 12 decodes (decompresses) the compressed clip info files in accordance with a predetermined algorithm.

However, when the data amount of the clip info files is less than a predetermined amount such that the transmitting time of the clip info files is to be less than a predetermined duration of time, the files is not required to be encrypted in the distribution server 4, and the decoder unit 12 accordingly may not perform the decoding process.

The management file memory unit 13, which is provided as a buffer memory, temporarily memorizes the play list file and the clip info files downloaded from the distribution server 4, and clears the files after the playback process of the content has been finished. Alternatively, the downloaded play list file and clip info files may be held without being changed nor cleared. In this case, the use of the held files enables the download time to be shortened when the same content is played again for audience.

The stream file memory unit 14, which is also provided as a buffer memory, temporarily memorizes the stream files downloaded from the distribution server 4, and clears each file after the playback process of the content has been finished. As shown in FIG. 2, a plurality of stream files reside to be sequentially downloaded in the present embodiment. The downloaded stream files are stored in order of precedence into the stream file memory unit (buffer memory), and each stream file is cleared after the playback has been finished.

The detector unit 16 detects a transmission speed through the internet 5 between the distribution server 4 and the player apparatus 1. This detection process may include detecting a transmission speed at the time of downloading the initial stream file (data amount thereof being given) or detecting a transmission speed of the stream file downloaded most recently. Alternatively, through transmitting an additional file for detecting speed with given data amount from the distribution server 4 to the player apparatus 1, the transmission speed of the additional file may be detected.

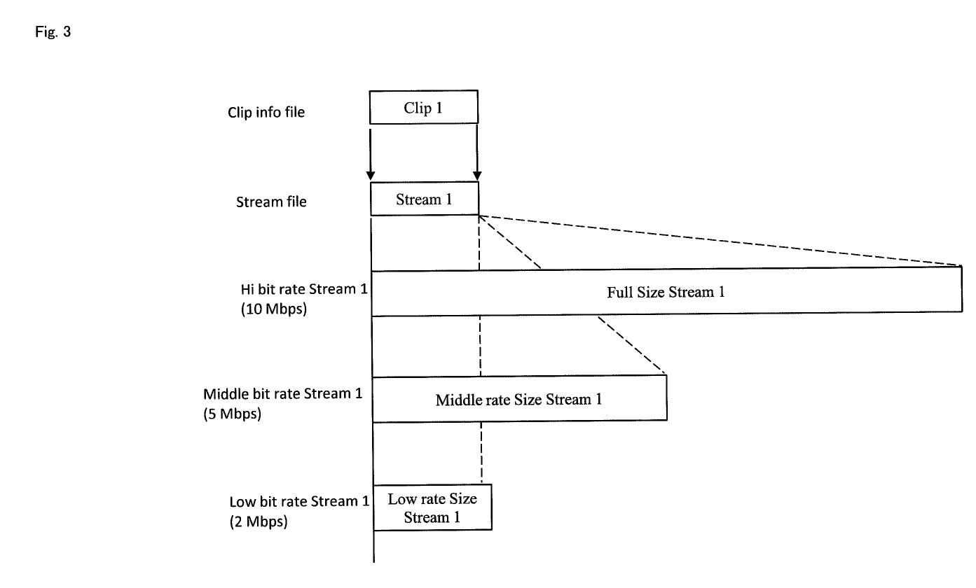

The selector unit 17 selects, in accordance with the present transmission speed detected by the detector unit 16, a stream file having an appropriate data amount from a plurality of stream files stored in the distribution server 4 with different data amounts. As shown in FIG. 3, three kinds of stream files with different data amounts are prepared for each stream file in the distribution server 4 according to the present embodiment. That is, the distribution server 4 has a contents memory unit 43 which stores three kinds of stream files directed to same content but with different data amounts, i.e. Hi bit rate stream file (corresponding to transmission speed of 10 Mbps) with the largest data amount, Low bit rate stream file (corresponding to transmission speed of 2 Mbps) with the smallest data amount, and Middle bit rate stream file (corresponding to transmission speed of 5 Mbps) with the data amount therebetween, for example shown as FIG. 3. The three stream files with different data amounts are prepared for each of the stream files 1, 2, . . . , n. It is to be noted that the size of data amount may be adjusted by changing frame rate fps, data compression ratio, resolution, and the like.

When the present transmission speed detected in the detector unit 16 is low, the download of the Hi bit rate stream file requires a long time. Therefore, the playback of the content may be interrupted because the playback of the preceding stream file has been completed while the download of the following stream file has not been completed.

Considering the above, the transmission speeds detected in the detector unit 16 are preliminarily classified into three ranges in the present embodiment, and the selector unit 17 selects the Hi bit rate stream file when the detected transmission speed is equal to or more than a first predetermined amount, the Low bit rate stream file when the detected transmission speed is equal to or less than a second predetermined amount which is smaller than the first predetermined amount, and the Middle bit rate stream file when the detected transmission speed is between the first and second predetermined amounts. This feature of the present embodiment enables to complete the download of the following stream file before completing the playback of the preceding stream file even though the transmission speed is low. In contrast, it is enabled to play a stream file with high resolution when the transmission speed is high.

The volume adjuster unit 15 adjusts the data amount of the stream file, which has been selected by selector unit 17 and downloaded, so as to become equal to a data amount specified in the corresponding clip info file.

The clip info file stores information relevant to a data amount of the corresponding stream file and performs a playback process by using the information with the play list file at the time of the playback. However, if the actual data amount of the stream file is different from the data amount specified in the clip info file, the playback process cannot be performed.

Particularly in the present embodiment, the play list file and the clip info files are initially downloaded to the management file memory unit 13, whereas the stream files are each selected as one stream file from the three kinds of data amounts in accordance with the transmitting speed. Accordingly, there is a case that the data amount of the stream file preliminarily specified in the clip info file and the data amount of the stream file actually downloaded are different from each other.

In the present embodiment, the clip info file is specified with the data amount of the Hi bit rate stream file. Therefore, when the Middle bit rate or the Low bit rate stream file is downloaded, the downloaded stream file is to have a data amount different from the data amount specified in the clip info file.

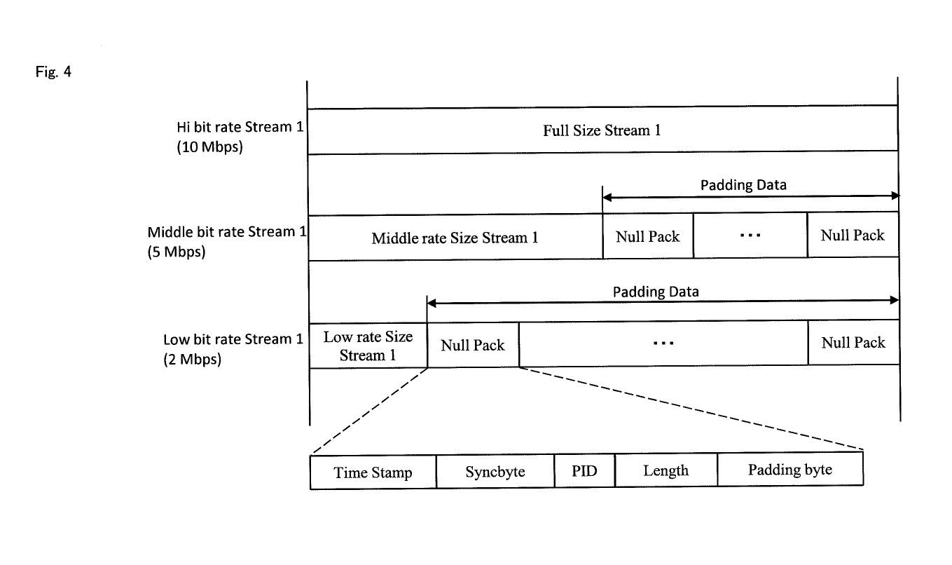

To this end, in the case that the selector unit 17 selects the Middle bit rate or the Low bit rate stream file and the selected stream file is downloaded, the volume adjuster unit 15 adds Padding data to the downloaded stream file such that the data amount of the stream file is adjusted to be equal to the data amount of the Hi bit rate stream file specified in the clip info file. More specifically, as shown in FIG. 4, empty data referred to as Null Packs are added to the Middle bit rate or the Low bit rate stream file depending on the data amount difference from that of the Hi bit rate stream file. The Null Packs are data for adjusting a data amount, and the player controller unit 18 ignores the Null Packs at the time of playback process.

The player controller unit 18 performs, based on the stream file adjusted by the volume adjuster unit 15 (which adjusts the Hi bit rate stream file without adding Padding data), the playback process in accordance with the playlist file and the clip info files, and outputs the result to the display apparatus 2. Through this, the progressive download playback of the downloaded content is achieved on the display apparatus 2.

The distribution server 4 has an input and output unit 41, a contents generator unit 42, and a contents memory unit 43. The input and output unit 41 inputs a live footage from an image pickup apparatus 3, such as a video camera, and a request signal from the player apparatus 1, and outputs a content stored in the contents memory unit 43. The contents generator unit 42 generates, based on the live footage input from the image pickup apparatus 3, digital data conforming to the BD-LIVE specification. The contents memory unit 43 stores the content generated in the contents generator unit 42.

As described above, the contents memory unit 43 stores, for each stream file, three kinds of stream files directed to same content but with different data amounts, i.e. Hi bit rate stream file (corresponding to transmission speed of 10 Mbps) with the largest data amount, Low bit rate stream file (corresponding to transmission speed of 2 Mbps) with the smallest data amount, and Middle bit rate stream file (corresponding to transmission speed of 5 Mbps) with the data amount therebetween.

The contents generator unit 42 also encrypts (compresses) a plurality of clip info files in accordance with a certain algorithm when the data amount of the plurality of clip info files is larger than or equal to a predetermined amount such that the transmitting time for the plurality of clip info files is longer than or equal to a predetermined duration of time.

In addition, the contents generator unit 42 extracts only I pictures included in the stream files of the generated content when a request signal for first forward or first rewind is input from the player apparatus 1. After being stored in the contents memory unit 43, the extracted I pictures are transmitted through the input and output unit 41 to the player apparatus 1.

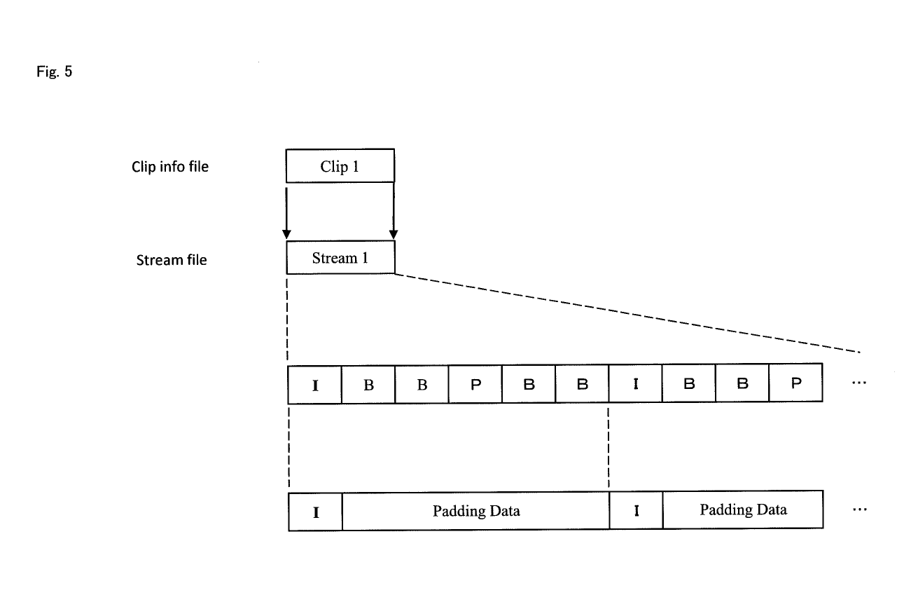

As shown in FIG. 5, each stream file contains I pictures (Intra Pictures) capable of being subjected to a decoding process for image generating without using another picture, B pictures as being coded with interpolated prediction from past and future reference frames, and P pictures as being coded with forward prediction from references made from previous frames. At the time of fast forward or fast rewind, only I pictures capable of independently generating images are transmitted to the player apparatus 1. After receiving I pictures at the player apparatus 1, the volume adjuster unit 15 adds padding data, which has a data amount corresponding to the data amount of B pictures and P pictures to have been existed, between each adjacent two I pictures. According to this process, fast forward or fast rewind operation is enabled to be achieved based on clip info files.

As described above, in the case that the progressive download playback is desired to be performed for the content, such as a movie for example, stored in the contents memory unit 43 of the distribution server 4, the player apparatus 1 sends out a request for the progressive download playback to the distribution server 4. After receiving the request, the distribution server 4 outputs, via the internet 5 to the input and output unit 11 of the player apparatus 1, a play list file and a plurality of clip info files as a part of the content stored in the contents memory unit 43, and the player apparatus 1 stores the play list file and the clip info files into the management file memory unit 13. At this time, if the data amounts of the clip info files are large, the clip info files are transmitted after being subjected to a compression process at the distribution server 4 side. In this case, the transmitted clip info files are stored into the management file memory unit 13 after being decompressed in the decoder unit 12 of the player apparatus 1.

After the download of the play list file and the clip info files has been completed, a plurality of stream files are sequentially downloaded. Hi bit rate stream file is firstly downloaded as an initial stream file, and the detector unit 16 detects a transmission speed by measuring the download time duration of the initial stream file. As the next stream file, the selector unit 17 selects a file having appropriate size from the three kinds of stream files depending on the detected transmission speed. For example, Low bit rate stream file of small size is selected for a low transmission speed, whereas Hi bit rate stream file of large size is selected for a high transmission speed. This download process is repeated until completing the download of the final stream file.

When the stream file selected by the selector unit 17 has a file size other than that of the Hi bit rate stream file, the volume adjuster unit 15 adds padding data to the selected stream file, as shown in FIG. 4, such that the data amount of the selected stream file becomes to correspond to the file size of the Hi bit rate stream file.

By using stream files with volumes adjusted in such a manner, the stream files are enable to be played based on the play list file and the clip info files stored in the management file memory unit 13. In addition, because the download is performed for a stream file selected by the selector unit 17 depending on the transmission speed so as to have an appropriate file size, the playback of the content is prevented from being interrupted during the playback.

For example, through the process that the image pickup apparatus 3 shown in FIG. 1 takes a live footage at an event site such as a sports meeting and transmits the live footage to the distribution server 4 via the internet 5, and the distribution server 4 generates a content based on the live footage, while the player apparatus 1 at a separated place from the event site accesses the distribution server 4, the live footage of sports meeting or the like is enabled to be watched in real time at the separated place.

### Second Embodiment

Known in the art is a recording apparatus for recording digital audio and visual information to a high density recording medium such as Blu-ray disc medium (hereinafter also abbreviated as BD). In the BD format, because Java (registered trade mark; the same shall apply hereinafter) program is allowed to be recorded in addition to audio and visual information, information from the server designated by the Java program is downloadable at the time of playback of BD.

According to the prior art BD, information is downloadable from a server assigned by a network accessing program regardless of BD, because it is unable to set the availability of access. Consequently, there has been desired to develop BD which allows only specified users to access specified servers.

Also according to the prior art, contents such as movies and Java program are printed or recorded onto a stamper, and BD's recorded with Java programs are produced by pressing the stamper. Accordingly, there has been desired to develop an apparatus capable of easily recording a required Java program in response to user's request in addition to audio and visual information.

The present embodiment provides, in addition to the above-described functional capabilities of the first embodiment, a system involving BD which allows only specified users to access specified servers. The present embodiment also provides a recording apparatus capable of recording, with simple operation, desired digital audio and visual information and desired Java program to BD.

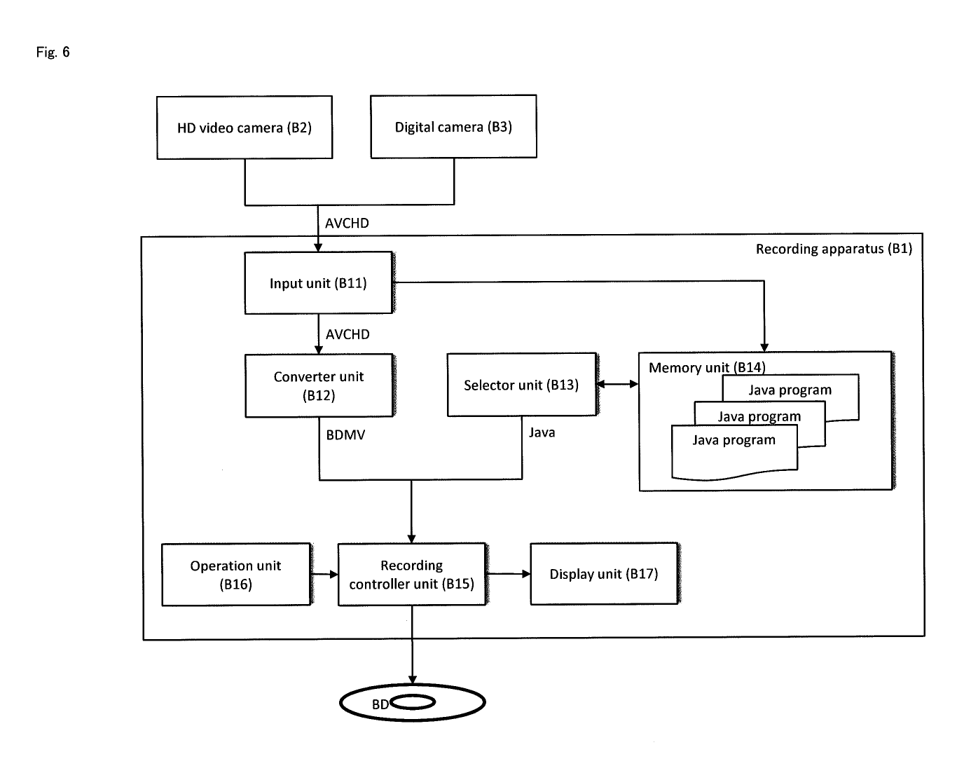

FIG. 6 is a block diagram illustrating a part of a digital audio and visual information recording apparatus B1 according to the present embodiment on the basis of the distribution system above-described in the first embodiment.

The recording apparatus B1 according to the present embodiment has an input unit B11, a converter unit B12, a selector unit B13, a memory unit B14, a recording controller unit B15, an operation unit B16, and a display unit B17. The input unit B11, which is provided as a USB terminal or the like, inputs digital audio and visual information obtained by image pickup apparatuses, such as a high definition (HD) video camera B2 and a digital camera B3. The converter unit B12 converts the input digital audio and visual information to an available form according to the BDMV format. The memory unit B14 stores Java programs each having one or more network access functions. The selector unit B13 selects one from Java programs stored in the memory unit B14. The recording controller unit B15 records, to Blu-ray disc medium BD, the digital audio and visual information converted to the BDMV format in the converter unit B12 and the selected Java program by the selector unit B13. The operation unit B16 is provided as buttons and the like in order for users to perform a command of recording start by the recording controller unit B15 and a command of selection by the selector unit B13. The display unit B17 is provided as a display to indicate the program selected by the selector unit B13, and the like.

The audio and visual information (possibly being only visual information) obtained by the HD video camera B2 or the digital camera B3 is loaded into the converter unit B12 via the input unit B11 because of being information defined in accordance with the format based on the DVD specification or the AVCHD (registered trademark) specification. More specifically or actually, a desired motion picture or still image is selected from a plurality of motion pictures or still images by using the operation menu of the display apparatus B2 or the digital camera B3, and the selected motion picture or still image is loaded from the image pickup apparatus side to the recording apparatus B1.

The converter unit B12 converts the audio and visual information defined according to the above DVD specification and the like to the audio and visual information matching to the BDMV format.

The memory unit B14 stores a plurality of Java programs. The use of the operation unit B16 allows a user to select a desired Java program from the plurality of Java programs displayed at the display unit B17. At this time, although one Java program is usually to be selected, a plurality of Java programs may be selected and recorded.

Alternatively, the recording apparatus B1 may be provided as recording a predetermined Java program as well as audio and visual information. In this case, the selector unit B13 may be omitted.

Recording of Java programs to the memory unit B14 may be achieved through the input unit B11 by using the operation unit B16. In addition, the memory unit B14 may be provided as a ROM to which Java program has been preliminarily recorded.

The recording controller unit B15 executes a control, in accordance with a command of recording start from the operation unit B16, for writing the audio and visual information of the BDMV format converted in the converter unit B12 and the Java program selected in the selector unit B13 to a Blu-ray disc BD.

By using the above recording apparatus B1, it is enabled to obtain a Blu-ray disc recorded with an audio and visual signal and Java program. Hereinafter, the performances of the Blu-ray disc BD prepared by the recording apparatus B1 will be described.

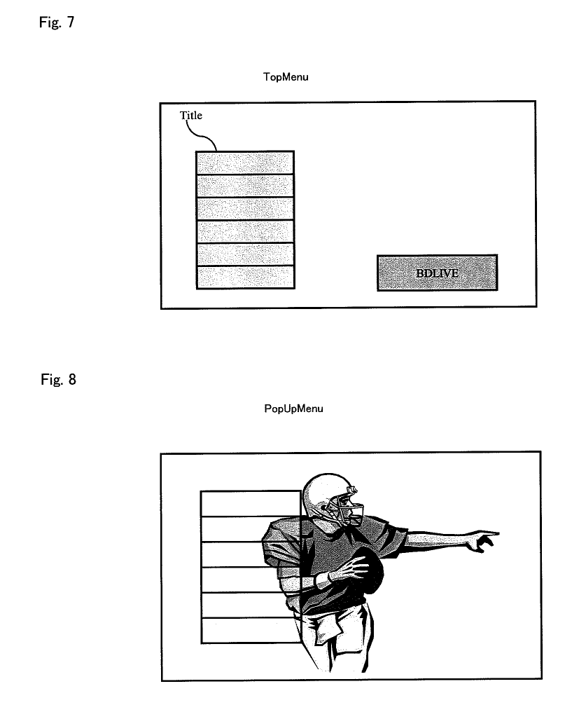

FIG. 7 is a view illustrating a top menu to be displayed at the time a Blu-ray disc BD prepared by using the above recording apparatus B1 is played on a player apparatus. Titles of the recorded audio and visual information are displayed on the left side, and an icon is displayed on the lower right for transition to the BD-Live according to the Java program.

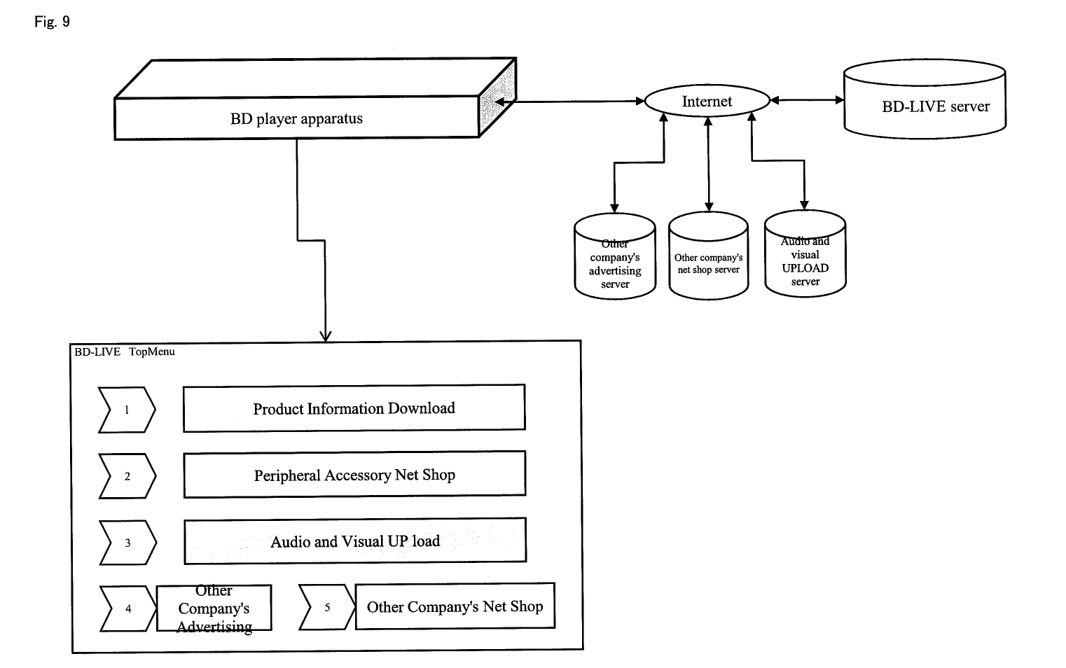

At the top menu illustrated in FIG. 7, selecting either one of the titles on the left side allows a motion picture or a still image to be displayed depending on the selected title as shown in FIG. 8. During the display of the audio and visual information, pressing the pop-up button of the player apparatus also allows the list of titles recorded on the Blu-ray disc BD to be displayed as shown in FIG. 8, thereby enabling to change the title to be displayed as necessary. Thus, motion pictures or still images are playable on the player apparatus in accordance with the playback operations.

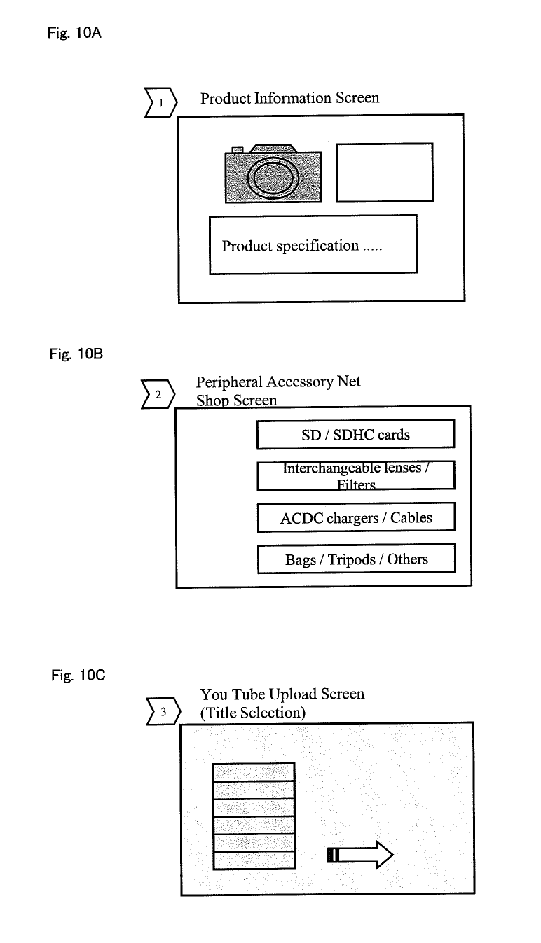

Then, at the top menu illustrated in FIG. 7, clicking the BD-Live icon on the lower right allows the Java program recorded in the Blu-ray disc BD to run, thereby displaying a top menu of the BD-Live as shown in the lower left of FIG. 9. Five items are displayed in the present embodiment as follows:
item 1 for automatically downloading information on the web which includes contents, such as product specifications and manuals for cameras, directed to products regarding the video camera and the digital camera used for taking the motion picture or the still image;
item 2 for accessing a shop on the web from which peripheral devices (accessories) for the camera are available;
item 3 for uploading the motion picture or the still image recorded to Blu-ray disc BD to a certain website, such as YOUTUBE (registered trademark);
item 4 for accessing an advertising website of the camera or of other company collaborating with the manufacturer of the camera; and
item 5 for accessing net shops of other companies collaborating with the manufacturer of the camera, such as Rakuten (registered trademark) and Amazon (registered trademark), for example.

Herein, if the item 1 or 2 is selected, the player apparatus is connected with a BD-Live server via the internet in accordance with Java program, and products information, peripheral devices information, and the like regarding the camera are downloaded thereby being displayed on the display of the player apparatus. Alternatively, if either one of the items 3 to 5 is selected, the player apparatus is connected with a BD-server via the internet, and further connected with other company's advertising server, other company's net shop server, or uploading server for audio and visual information via the BD-Live server and the internet.

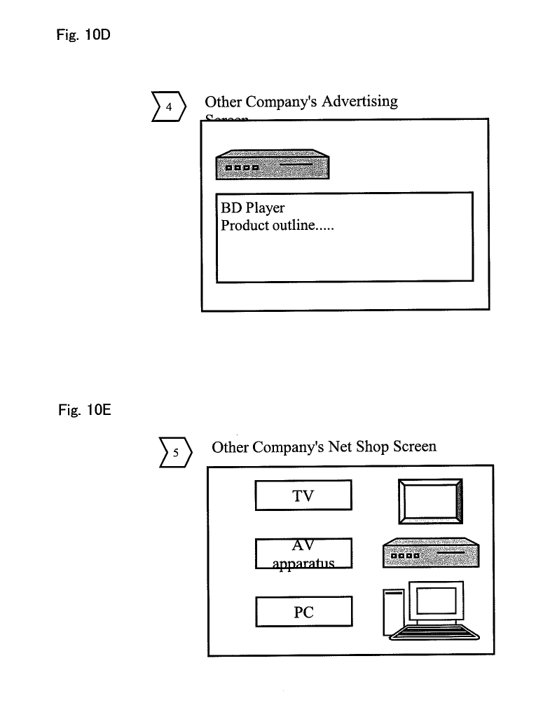

FIG. 10A is a view illustrating an example of display for product information when the item 1 is selected in FIG. 9. Because Java program is recorded to the Blu-ray disc BD so as to contain the model number or the like of the camera, the player apparatus is enable to access the relevant website among BD-Live servers and display the product information on the display thereof. Through this, users can obtain the product specification, the manual, and the like for the camera. On the other hand, for the manufacturer of the camera, it is expected that advertising and expanding sales are achieved effectively because customer retention is possible through that the Blu-ray disc BD is recorded with Java program which allows users to automatically obtain information of the camera products of the manufacturer.

FIG. 10B is a view illustrating a display example for a net shop of peripheral devices when the item 2 is selected in FIG. 9. As described above, because Java program is recorded to the Blu-ray disc BD so as to contain the model number or the like of the camera, the player apparatus is enable to access the net shop posting peripheral devices relevant to the model number and to display, on the display of the player apparatus, information for the peripheral devices including recording mediums such as SD cards and SDHC cards, interchangeable lenses and filters for the camera, AC/DC battery chargers, cables, carrying bags for the camera, tripods, and the like. Consequently, users can easily buy in the peripheral devices of the camera. In addition, for the manufacturer of the camera, it is expected that advertising and expanding sales are achieved effectively through customer retention similarly as the above item 1.

FIG. 10C is a view illustrating an example of upload menu to be displayed on the display of the player apparatus when the item 3 is selected in FIG. 9. Java program of the Blu-ray disc BD is recorded with the URL of a website (such as YOUTUBE (registered trademark) described above) to which motion pictures and still images may be freely uploaded. After accessing the website according to the program, the selection of upload allows to display the list of motion pictures and still images recorded to the Blu-ray disc BD as shown in FIG. 10C. By further selecting a picture or image desired to be uploaded from the list, it is enable to easily upload the picture or image shot by the user to the website.

FIG. 10D is a view illustrating a display example of information for other company's product when the item 4 is selected in FIG. 9. Herein, the term “other company” is intended to mean a camera manufacturer or the like which collaborates with the manufacturer of the camera concerned. The manufacturer of the camera concerned may be paid as an advertising income for services to provide its sales network to the other company. In addition, users can obtain information not only about the camera concerned but also about cameras provided by other manufacturers.

FIG. 10E is a view illustrating a display example of a net shop when the item 5 is selected in FIG. 9. Also in this case, similarly as the item 4, the manufacturer of the camera concerned may be paid as an advertising income for services to introduce its customers to the net shop, because the customers access the net shop collaborating with the manufacturer of the camera concerned. In addition, users can easily obtain information relevant to the camera and the like from the net shop.

Although not shown, in the case of selecting the item 1 or the item 2 (FIG. 10A or FIG. 10B), Java program may includes a step for accessing a plurality of servers alternatively to accessing one server, thereby providing a system in which information screens to be downloaded are sequentially changed at predetermined time intervals, or the user selects a desired server among the plurality of servers from the popup menu displayed on the initial download screen.

In general, Blu-ray disc BD is preliminarily recorded with an identifier unique to the medium. Java program may include a step for transmitting the unique identifier to a server via the player apparatus. In this case, the server received with the unique identifier is capable of selecting information to be provided depending on the unique identifier. Furthermore, the server may allow the player apparatus to display, on the display thereof, history information obtained through recording past information which has been provided. This alternative embodiment will hereinafter be described in detail.

In addition, Java program may include a step for storing a so-called book marker function to the player apparatus. That is, by pressing a book marker button of the player apparatus at a certain scene during the playback of the Blu-ray disc BD, the address of the scene is registered to the memory unit of the player apparatus. The book marker is used for searching the scene and jumping to the scene by selecting the registered book marker at the time of re-playback.

Moreover, Java program may include a play (game) program, thereby providing a system which allows the player apparatus to run the game program.

### Third Embodiment

As described above, the second embodiment provides features including that the image pickup apparatuses, such as the video camera B2 and the digital camera B3, take digital audio and visual information, that the recording apparatus B1 shown in FIG. 6 records the digital audio and visual information to Blu-ray disc medium BD with Java program having network accessing function, and that the player apparatus is connected with the BD-Live server shown in FIG. 9 by using the Blu-ray disc medium BD. The second embodiment further provides additional features, as aspects of one embodiment, that a unique identifier preliminarily recorded to the Blu-ray disc medium BD is transmitted to the server, that the server selects information to be provided depending on the unique identifier, and that the server allows the player apparatus to display, on the display thereof, history information obtained through recording past information which has been provided.

As another embodiment, accessing the BD-Live server may be performed by using Blu-Ray disc medium BD recorded, through pressing and the like, with Java program having a network accessing function and the unique identifier ID of the medium.

This type of medium BD-ROM is provided as a supplement to a book, catalog, or the like, and the user who received the medium sets it to the BD player apparatus shown in FIG. 9, then Java program starts to run. Thus, the BD player apparatus is connected via the network with the BD-Live server assigned by the Java program.

In the above-described second embodiment, the server is configured so as to start up the top menu shown in FIG. 9 without any restriction after the player apparatus accesses the BD-Live server, whereas in the present embodiment, by reading out the unique identifier ID stored with Java program in the BD-Live medium, the BD-Live server allows the output of the top menu and the information subsequent thereto to be output, or selects the contents to be output, in accordance with the unique identifier ID.

That is, in the system shown in FIG. 9, the BD-Live server is installed with a program for reading out the unique identifier ID stored in the medium BD-ROM, and the server reads out the unique identifier ID of the Medium BD-ROM just accessing the server. Although the program for reading out the unique identifier is storable in the medium BD-ROM itself, it is preferred that the program is installed only in the BD-Live server because if the program is stored in the medium, there is a possibility that the logic of the program for reading out is dissolved and counterfeited.

In the present embodiment, the BD-Live server is preliminarily input with the unique identifier ID to be allowed to access, and determines whether or not to perform the information output by comparing the input unique identifier ID with the unique identifier ID of the medium just accessing. If the unique identifier is to be allowed, the top menu shown in FIG. 9 is provided and the downloading of the contents subsequent to the top menu is also allowed. If the unique identifier of the medium BD-ROM just accessing is not to be allowed, a string of characters calling for attention, such as “cannot connect to . . . ” is output to the BD player apparatus.

According to such medium BD-ROM, a specified BD-Live server is automatically accessed by a specified medium thereby to provide specified contents to a specified user.

### Fourth Embodiment

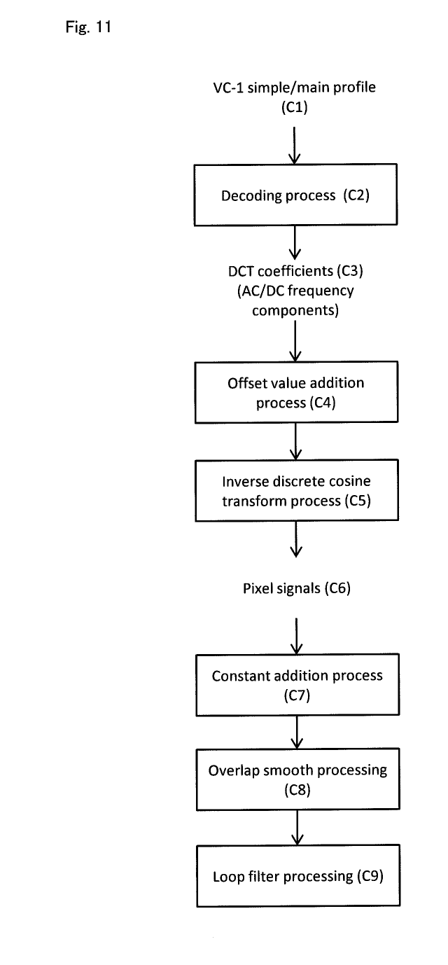

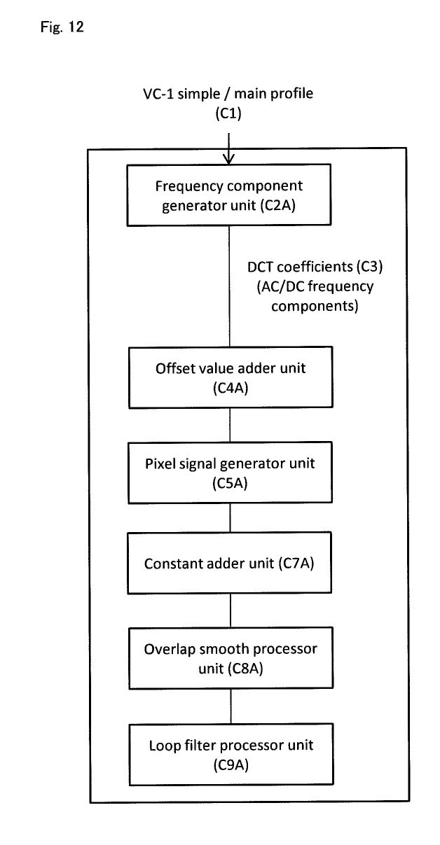

FIG. 11 is a flow chart illustrating a conversion processing method of picture signal according to the fourth embodiment of the present invention, and FIG. 12 is a block diagram illustrating a conversion processing apparatus of picture signal according to the same.

Hereinafter, aspects of the present invention will be described referring to an embodiment where a motion picture of the simple profile or the main profile according to the VC-1 encoding format is converted in real time to a file format playable on Blu-ray player apparatus. It is to be noted that the converting method, the converting apparatus, and the converting program according to the present embodiment may be provided for the distribution server 4 according to the first embodiment shown in FIG. 1. Through this, the picture data stored in the contents memory unit 43 according to the VC-1 encoding format is enable to be converted in real time, thereby being output to the player apparatus 1.

At the time of encoding (compression processing herein) a discrete pixel signal obtained by sampling a plurality of pixel signals (analog signals) in accordance with the VC-1 encoding format, the simple profile or the main profile according to the VC-1 encoding format pre-processes the pixel signal by using Discrete Cosine Transform (DCT) in order for the compression ratio to be heightened still more.

The Discrete Cosine Transform is a conversion process for resolving analog signals as original pictures into frequency components such as low frequency components and high frequency components by using an algorithm referred to as mathematical discrete cosine transform, and is available as a pre-process prior to mainly extracting the low frequency components sensitive for human eyes and removing the high frequency components less responsive to visual feature, for example.

The frequency components (referred to as “DCT coefficients”) of pixel signals subjected to the Discrete Cosine Transform process are compression processed by a VC-1 encoder and recorded as a VC-1 simple or main profile C1.

In the present embodiment, a pre-process for header information is executed for the VC-1 simple or main profile C1 recorded in such a manner, and a header information table required at the time of decoding is prepared.

More specifically, as the header information of a VC-1 stream, a sequence header, a picture layer, and a macro block layer of the simple profile or the main profile are converted into those of the advanced profile. In addition, a slice layer is added because it is not included in the simple profile nor the main profile but is required for the advanced profile.

After the pre-process, a decoding process C2 (expanding process herein) is executed for the above VC-1 simple or main profile C1 by a decoder according to the VC-1 as shown in FIG. 11, thereby generating frequency components C3 of the picture signal, i.e. a direct current component and alternative current components. These frequency components correspond to DCT coefficients C3 according to the Discrete Cosine Transform executed as the above pre-process prior to the compression process. In the conversion processing apparatus shown in FIG. 12, a frequency component generator unit C2A executes this process.

Then, an offset value is added to each DCT coefficient C3 for each pixel signal in accordance with a constant to be added through a constant addition process herein after described (an offset value addition process C4 shown in FIG. 11 and an offset value adder unit C4A shown in FIG. 12).

In the decoding process for the advanced profile according to the VC-1, an addition process C7 with a constant at the pixel coordinate is performed for each of pixel signals C6 obtained by subjecting the DCT coefficients C3 to an inverse discrete cosine transform process C5. On the contrary, the addition process with a constant is not performed in the decoding process for the simple profile and the main profile. Therefore, if the simple profile or the main profile is decoded by a decoding algorithm for the advanced profile, that is, played by a Blu-ray player apparatus, the color or the brightness is shifted depending on the constant to be added, and the original pictures cannot be reproduced.

To this end, according to the present embodiment, there is preliminarily added to each DCT coefficient an offset value corresponding to the constant to be added through the decoding algorithm for the advanced profile, i.e. an offset value for compensating for the constant, thereby providing the color and the brightness of the original pixel signal at the time of being added with the constant in the constant addition process C7. For example, because the constant to be added is specified to be 128 according to the standard specification SMPTE421M (VC-1 Compressed Video Bitstream Format and Decoding Process) of Society of Motion Picture and Television Engineers (SMPTE), the offset value is set to be 128.

It should be noted that, while the constant to be added in the constant addition process C7 is a constant within a range of pixel coordinate, −128 to +128, for example, a frequency component as an objective to which the offset value is added in the offset value addition process C4 exists within a frequency component coordinate, 0 to 256, for example. That is, both the coordinate dimensions may be different from each other. Consequently, the relationship between the pixel coordinate and the frequency coordinate is preliminarily set, and the offset value is added to each DCT coefficient C3 in the offset value addition process C4 after being calculated so as to correspond to the constant to be added in the constant addition process C7.

After being added with the offset value, each DCT coefficient is subjected to the inverse discrete cosine transform process C5 thereby generating the pixel signal C6. The above discrete cosine transform is a reversible process. Therefore, by executing the inverse discrete cosine transform process, the pixel signals C6 can be obtained as being offset with the colors and the brightnesses depending on the offset value. The conversion processing apparatus shown in FIG. 12 has a pixel signal generator unit C5A for performing this process.

Then, the constant is added to each pixel signal C6 (the constant addition process C7 shown in FIG. 11 and a constant adder unit C7A). As described above, the constant addition process C7 is an algorithm specific to the decoding process for the advanced profile, and does not exist for the decoding process of the simple profile and the main profile. Nevertheless, because of preliminarily taking the addition of the constant into consideration by the offset value addition process C4 for frequency components, pixel signals obtained as the result of the constant addition process C7 are to have colors and brightnesses of pixel signals recorded as the simple profile or the main profile.

Finally, a predetermined overlap smooth processing C8 and a loop filter processing C9 are executed, and there are obtained pixel signals decoded (enlarged). The conversion processing apparatus shown in FIG. 12 involves an overlap smooth processor unit C8A and a loop filter processor unit C9A for this processing.

As described above, the conversion processing method of picture signals according to the present embodiment merely involves a supplementary processing for adding a predetermined offset value to each DCT coefficient, and such addition processing of the offset value can be realized by a simple program. Therefore, it is enable to play in real time the simple or main profile of VC-1 through using an algorithm same as for the advanced profile, i.e. using Blu-ray player apparatus.

### DESCRIPTION OF REFERENCE NUMERALS

1; player apparatus

11; input and output unit

12; decoder unit

13; management file memory unit

14; stream file memory unit

15; volume adjuster unit

16; detector unit

17; selector unit

18; player controller unit

2; display apparatus

3; image pickup apparatus

4; distribution server

41; data input and output unit

42; contents generator unit

43; contents memory unit

5; internet

B1; recording apparatus

B11; input unit

B12; converter unit

B13; selector unit

B14; memory unit

B15; recording controller unit

C1; simple profile/main profile

C2; decoding process

C2A; frequency component generator unit

C3; DCT coefficients

C4; offset value addition process

C4A; offset value adder unit

C5; inverse discrete cosine transform process

C5A; pixel signal generator unit

C6; pixel signals

C7; constant addition process

C7A; constant adder unit

1. A distribution system of contents, comprising:
a distribution server stored with a content having a management file and a plurality of stream files with different data amounts; and
a player apparatus for downloading the content via a communication line and starting playback of the content during the downloading,
the player apparatus comprising:
a management file memory unit for downloading and temporally memorizing the management file;
a detector unit for detecting a transmission speed through the communication line;
a selector unit for selecting a stream file with a data amount depending on the transmission speed detected by the detector unit, from the plurality of stream files stored in the distribution server with different data amounts;
a stream file memory unit for downloading and temporally memorizing the stream file selected by the selector unit;
a volume adjuster unit for adding a padding data such that the data amount of the stream file becomes equal to a data amount specified in the management file when the data amount of the stream file is different from the data amount specified in the management file; and
a player controller unit for playback processing the stream file adjusted by the volume adjuster unit,
the distribution server extracting and outputting only an I picture included in the stream file when the player apparatus outputs a request for fast forward or fast rewind of playback to the distribution server,
the player apparatus temporally memorizing a plurality of I pictures downloaded, adding a padding data such that data amounts of the plurality of I pictures become equal to an inherent data amount of the stream file, and playing the I pictures based on a clip info file included in the management file.

2. The distribution system of contents as recited in claim 1, further comprising a data acquisition apparatus for acquiring and outputting a digital data, wherein
the distribution server is input with the digital data from the data acquisition apparatus via the communication line and generates, based on the digital data, the content having the management file and the stream file.

3. The distribution system of contents as recited in claim 1, wherein
the player apparatus starts to run a program having one or more network accessing functions and accesses a server designated by the program via a network, the program being stored in a Blu-ray disc medium with a unique identifier of the medium, and
the distribution server is assigned with a unique identifier of a Blu-ray disc medium to be allowed to output the content, is installed with a program to read out the unique identifier of the Blu-ray disc medium, reads out the unique identifier of the Blu-ray disc medium accessing the distribution server, determines whether or not the read out unique identifier is same as the assigned unique identifier, and outputs the content to the player apparatus when the read out unique identifier is same as the assigned unique identifier.

4. The distribution system of contents as recited in claim 1, further comprising a recording apparatus for generating a content and recording the content to a Blu-ray disc medium,
the recording apparatus comprising:
an input unit for inputting a digital audio and visual information obtained by an external image pickup apparatus;
a converter unit for converting the input digital audio and visual information to a digital audio and visual information of BDMV format;
a memory unit stored with a program having one or more network accessing functions, the program including executable instructions that cause the player apparatus to connect with a predetermined server and to download information relevant to the image pickup apparatus; and
a recording controller unit for recording the digital audio and visual information of BDMV format converted by the converter unit and the program stored in the memory unit to the Blu-ray disc medium.

5. The distribution system of contents as recited in claim 4, wherein
the recording apparatus further comprises a selector unit for selecting a program from a plurality of programs stored in the memory unit, and
the recording controller unit records the digital audio and visual information of BDMV format converted by the converter unit and the program selected by the selector unit to the Blu-ray disc medium.

6. The distribution system of contents as recited in claim 4, wherein the program further includes an executable instruction causing the player apparatus to connect sequentially or selectively with a plurality of predetermined servers.

7. The distribution system of contents as recited in claim 4, wherein
the program transmits a unique identifier of the Blu-ray disc medium to a distribution server connected with the player apparatus, the unique identifier being preliminarily recorded to the Blu-ray disc medium or recorded by the recording apparatus, and
the distribution server selects information to be transmitted in accordance with the transmitted unique identifier of the Blu-ray disc medium.

8. The distribution system of contents as recited in claim 4, wherein the program further includes executable instructions that cause the player apparatus to connect with a certain server and to upload the digital audio and visual information recorded to the blu-ray disc medium to the certain server.

9. The distribution system of contents as recited in claim 4, wherein the program further includes an executable instruction causing the player apparatus to record a desired information position to a memory unit of the player apparatus during playback of the digital audio and visual information recorded to the Blu-ray disc medium.

10. The distribution system of contents as recited in claim 4, wherein the program further includes an executable instruction causing the player apparatus to search a desired information position during playback of the digital audio and visual information recorded to the Blu-ray disc medium.

11. The distribution system of contents as recited in claim 4, wherein the program further includes a game program.

12. A program for a player apparatus that performs a downloading of a content having a management file and a stream file from a distribution server via a communication line and starts playback of the content during the downloading,
the program comprising executable instructions that cause the player apparatus to:
download and temporally memorize the management file;
detect a transmission speed through the communication line;
select a stream file with a data amount depending on the detected transmission speed, from a plurality of stream files stored in the distribution server with different data amounts;
download and temporally memorize the selected stream file;
add a padding data such that the data amount of the stream file becomes equal to a data amount specified in the management file when the data amount of the memorized stream file is different from the data amount specified in the management file; and
playback process the adjusted stream file,
upon that the player apparatus outputs a request for fast forward or fast rewind of playback to the distribution server, and the distribution server extracts and outputs an I picture included in the stream file,
the program further comprising executable instructions that cause the player apparatus to:
temporally memorize a plurality of I pictures downloaded;
add a padding data such that data amounts of the plurality of I pictures become equal to an inherent data amount of the stream file; and
play the I pictures based on a clip info file included in the management file.

13. The program as recited in claim 12, wherein
the management file includes a play list file and the clip info file, and
the clip info file specifies the data amount of the stream file to a maximum data amount among the plurality of stream files with different data amounts.

14. The program as recited in claim 13, wherein the content contains, for each play list file, a plurality of stream files and a plurality of clip info files respectively corresponding to the plurality of stream files.

15. The program as recited in claim 14, further comprising an executable instruction that causes the player apparatus to decode the plurality of clip info files downloaded after being encoded into one file by the distribution server.

16. A conversion processing method for a picture signal of a simple profile or a main profile, the picture signal being obtained through subjecting a picture signal given by discrete pixel signal groups to a signal transform process into frequency components and encoding the frequency components in accordance with a VC-1 encoding format, the picture signal of the simple profile or the main profile being subjected to a decoding process with an algorithm same as for a decoding process of an advanced profile encoded in accordance with the VC-1 encoding format, the conversion processing method comprising:
generating a frequency component of signal by decoding a pixel signal of the simple profile or the main profile;
addition processing an offset value to the frequency component of signal, the offset value being of a frequency component depending on a constant to be added to a pixel signal in the decoding process of the advanced profile;
generating a pixel signal through subjecting the frequency component of signal added with the offset value to an inverse signal transform process having an inverse relation to the signal transform process; and
adding the constant to the pixel signal generated through the inverse signal conversion process.

17. The conversion processing method for a picture signal as recited in claim 16, wherein the signal transform process is a discrete cosine transform process.

18. A conversion processing apparatus for a picture signal of a simple profile or a main profile, the picture signal being obtained through subjecting a picture signal given by discrete pixel signal groups to a signal transform process into frequency components and encoding the frequency components in accordance with a VC-1 encoding format, the picture signal of the simple profile or the main profile being subjected to a decoding process with an algorithm same as for a decoding process of an advanced profile encoded in accordance with the VC-1 encoding format, the conversion processing apparatus comprising:
a frequency component generator unit for generating a frequency component of signal by decoding a pixel signal of the simple profile or the main profile;
an offset value adder unit for addition processing an offset value to the frequency component of signal, the offset value being of a frequency component depending on a constant to be added to a pixel signal in the decoding process of the advanced profile;
a pixel signal generator unit for generating a pixel signal through subjecting the frequency component of signal added with the offset value to an inverse signal transform process having an inverse relation to the signal transform process; and
a constant adder unit for adding the constant to the pixel signal generated through the inverse signal conversion process.

19. A conversion processing program for a picture signal of a simple profile or a main profile, the picture signal being obtained through subjecting a picture signal given by discrete pixel signal groups to a signal transform process into frequency components and encoding the frequency components in accordance with a VC-1 encoding format, the picture signal of the simple profile or the main profile being subjected to a decoding process with an algorithm same as for a decoding process of an advanced profile encoded in accordance with the VC-1 encoding format, the conversion processing program comprising executable instructions that cause a computer to:
generate a frequency component of signal by decoding a pixel signal of the simple profile or the main profile;
addition process an offset value to the frequency component of signal, the offset value being of a frequency component depending on a constant to be added to a pixel signal in the decoding process of the advanced profile;
generate a pixel signal through subjecting the frequency component of signal added with the offset value to an inverse signal transform process having an inverse relation to the signal transform process; and
add the constant to the pixel signal generated through the inverse signal conversion process.
